(19) United States
(12) Patent Application Publication
(10) Pub. No.: US 2014/0233065 A1
(43) Pub. Date: Aug. 21, 2014

(54) Proofing of a Product Over a Network

(71) Applicants: Mani Fischer, Haifa (IL); Doron Shaked, Tvon (IL); Randall Edward Grohs, Star, ID (US); William J. Allen, Corvallis, OR (US); Craig R. White, Eagle, ID (US); Zachi Karni, Givat Ella (IL); Adriane De Quevedo Cardozo, Porto Alegre (BR)

(72) Inventors: Mani Fischer, Haifa (IL); Doron Shaked, Tvon (IL); Randall Edward Grohs, Star, ID (US); William J. Allen, Corvallis, OR (US); Craig R. White, Eagle, ID (US); Zachi Karni, Givat Ella (IL); Adriane De Quevedo Cardozo, Porto Alegre (BR)

(21) Appl. No.: 14/347,275

(22) PCT Filed: Oct. 31, 2011
(86) PCT No.: PCT/US11/58631

§ 371 Date: Mar. 26, 2014

(51) Int. Cl. G06F 3/12

(52) U.S. Cl. CPC G06F 3/1293; G06F 3/1296
USPC 358/1.15

(57) ABSTRACT

A system for proofing a product over a network comprising a first computing device (110) that receives a product from a user, an operation module (191) that analyzes the product for print intent parameters, and a second computing device (185) that allows a user to finalize the product through a three-dimensional visualization, in which finalization by the user of the product causes a contract to be established between the user and a selected print shop provider (115).

### BACKGROUND

After generating a printable work, a consumer may wish to have a number of physical copies of the work produced. One option a consumer has is to have a print shop provider produce the physical copies. Communication between the consumer and print shop provider is generally done manually with the customer submitting to the print shop provider, via email for example, an electronic copy of the work to be printed. After the print shop provider has received the electronic copy, the consumer may then provide additional specific information regarding how the consumer wants the product to look. For example, the consumer may dictate to the print shop provider information regarding the purpose of the product, the paper style that the product is to be printed on, the cover and page style, binding type, areas of the product to be folded, amongst others.

Even after this exchange of information is completed, many ambiguities as to how the consumer intended the final printed product to look may still be left unresolved. The print shop provider would then be left to exercise their best guess or expertise to determine how these ambiguities are to be resolved. Having done so, the print shop provider and consumer would then go through a redrafting process which may include a number of physical draft copies sent back and forth between them.

To alleviate some of the effort experienced during this process, the print shop provider may have available a number of templates a consumer may review so as to more easily choose the look of the final product. The use of templates, however, may still result in a number of draft copies sent back and forth between the print shop provider and the consumer. Additionally, the use of templates may limit the usability of the product and reduce the consumers' options.

### BRIEF DESCRIPTION OF THE DRAWINGS

The accompanying drawings illustrate various examples of the principles described herein and are a part of the specification. The illustrated examples do not limit the scope of the claims.

FIG. 1 is a diagram of a system for providing communication between a user and a print shop provider and proofing a product for printing according to one example of the principles described herein.

FIG. 2 is a flowchart showing a method of proofing a product for printing according to one example of the principles described herein.

FIG. 3 is a flowchart showing another method of proofing a product for printing according to one example of the principles described herein

Throughout the drawings, identical reference numbers designate similar, but not necessarily identical, elements.

### DETAILED DESCRIPTION

Therefore, the present specification describes a system and method of proofing a printable product over a computer network system. The system may provide a user with the ability to establish the features, quality and characteristics of a printable product. After the user has established these features and characteristics, the user may preview the product via a three-dimensional realistic virtualization of the final product. During preview, the user may further define some features or make establish additional features. Subsequent to reviewing and refining the product via the three-dimensional realistic virtualization of the final product, the user may accept the final product and otherwise cause a message to be delivered to a print shop provider through a network who will then create physical copies of the product. In an example, final approval of the product by the user establishes a formal contract between the user and the print shop provider.

In an example the print shop provider is allowed to establish services which the print shop provider can provide to a user. Consequently, the network may serve as a virtual location where print shop providers may list out or otherwise add types of services that they are willing and capable of performing for a user. Additionally, the user may upload products to be printed by the print shop provider to the network, alter the product as the user may see fit, view a final three-dimensional realistic virtualization of the product, and contract with a print shop provider to produce a number of physical copies of the product.

In the present specification and in the appended claims, the term “product” is meant to be understood broadly as any work produced by an author. In some examples, the product may be in an electronic form such a word processing file or image file and may be intended to be converted into a physical item by a print shop provider or other similar service provider.

Additionally, in the present specification and in the appended claims, the term “print shop provider” is meant to be understood broadly as any person or entity that provides or is capable of providing printing and associated services to a user or customer of the system described in the present specification. The print shop provider may be capable of receiving a draft or final version of a product and, according to a three-dimensional virtualization, produce a physical copy for a user.

Further, in the present specification and in the appended claims, the term “user,” “consumer,” or “customer” is meant to be understood broadly as any entity implementing the system as described in the specification in order to print or have printed a product. In one example, the user can be an individual person or member of an organization. In another example, the user can be software, hardware, firmware, or a combination of these and may, at least, analyze a three-dimensional virtualization of the product by using computer vision technology or by examining three-dimensional data to determine if the three-dimensional virtualization is acceptable.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an example” or similar language indicates that a particular feature, structure, or characteristic described in connection with that example is included as described, but may not be included in other examples.

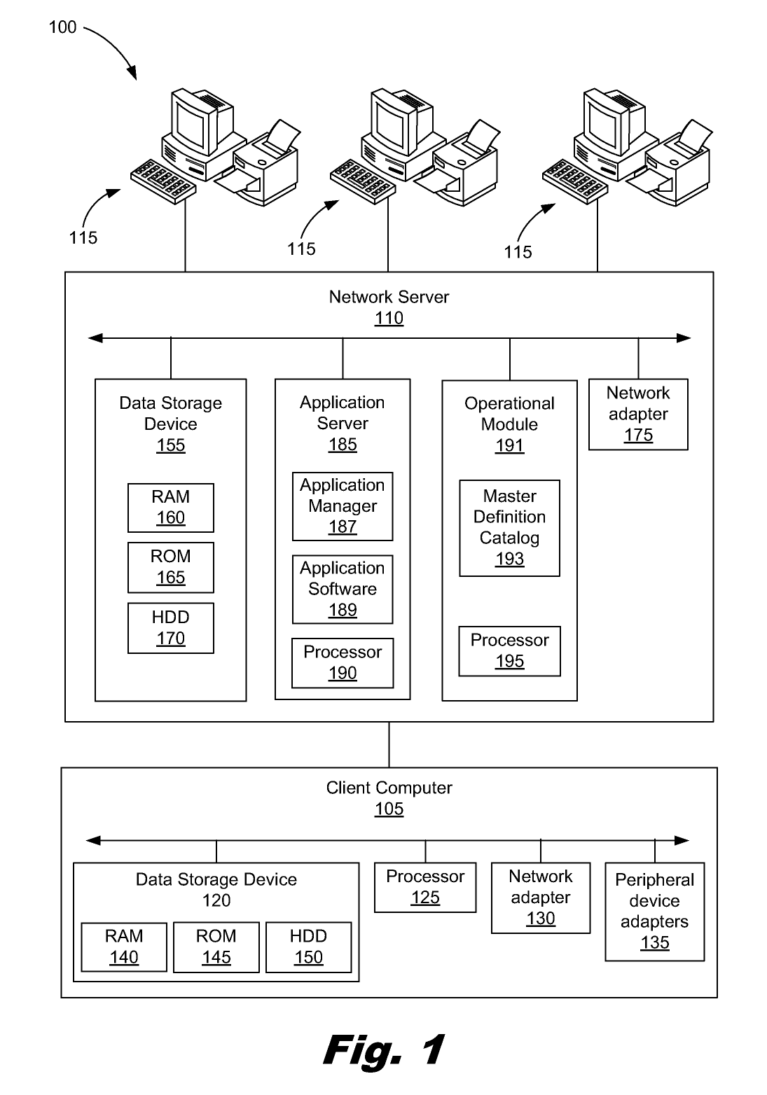

FIG. 1 is a diagram of a system (100) for providing communication between a user and a print shop provider according to one example of principles described herein. The system (100) includes at least one client computer (105), a network server (110), and a least one print shop provider (115). Each of these will now be described on more detail.

The client computer (106) may be used by a user to upload a product to the network server (110). The client computer (105) may, therefore, further comprise a data storage device (120), a processor (125), a network adapter (130), and a number of peripheral device adapters (135). The data storage device (120) may digitally store data consumed and produced by the processor (125). The data storage device (120) may include various types of memory modules, including volatile and nonvolatile memory. For example, the data storage device (120) of the present example includes Random Access Memory (RAM) (140), Read Only Memory (ROM) (145), and Hard Disk Drive (HDD) memory (150). Many other types of memory are available, and the present specification contemplates the use of any type of data storage device (120) as may suit a particular application of the principles described herein. In certain examples, different types of memory in the data storage device (120) may be used for different data storage needs. For example, in certain examples the processor (125) may boot from ROM (145), maintain nonvolatile storage the HD memory (150), and execute program code stored in RAM (140).

The peripheral device adapters (135) enable the processor (125) to interface with various other hardware elements, external and internal to the client computer (105). For example, peripheral device adapters (135) may provide an interface to input/output devices to create a user interface and/or access external sources of memory storage. Peripheral device adapters (135) may also create an interface between the processor (125) and a graphical user interface or other media output device. For example, in the examples where the client computer (105) generates a product, the client computer (105) may allow the user to implement an input device such as a mouse or keyboard to alter a product and display on the graphical user interface the product.

A network adapter (130) may provide an interface to the network (110), thereby enabling the transmission of data, such as the customers' products, to the devices associated with the network (110). The network adapter (130) may also serve to pass other data such as data associated with an email, a webpage, and an online program, amongst others.

As mentioned above, the client computer (105) may also include a processor (125). The processor (125) may include hardware architecture that retrieves executable code from the data storage device (120) and executes the executable code, The executable code may, when executed by the processor (125), cause the processor (125) to implement at least the functionality of creating and sending a product to a network server (110). In the course of executing code, the processor (125) may receive input from and provide output to any of the hardware units included in the client computer (105) and network server (110).

The network server (110) may include similar elements as those found in the client computer (105). In one example, the network server (110) may be located on one physical server. In another example, the network server (110) may have various types and numbers of components distributed over a number of different servers and associated with the network server (110). In yet another example the network server (110) may be implemented a cloud computing environment.

The network server (110) may comprise a data storage device (155) and a network adapter (175). The data storage device (155) may digitally store data received from or produced by a processor (190, 195) associated with the network server (110). The data storage device (155) may include Random Access Memory (RAM) (160), Read Only Memory (ROM) (165), and Hard Disk Drive (HDD) memory (170). Many other types of memory are available, and the present specification contemplates the use of any type of data storage device (155) as may suit a particular application of the principles described herein. In certain examples, different types of memory in the data storage device (155) may be used for different data storage needs.

The network adapter (175) may provide an interface between the client computer (105), the network server (110), and a number of print shop providers (115) thereby enabling the transmission of data, such as the customer's product, to the devices associated with the network (110) and the print shop providers (115). The network adapter (175) may also serve to pass other data such as data associated with an email, a webpage, and an online program, amongst others.

The network server (110) may also include an application server (185). The application server (185) may serve to allow a user, via a network connection, to create, alter, or otherwise interpret a user's product. in one example, the user may upload a product and the application server (185) may receive the upload. Once the application server (185) has received the product, an application manager (187) may address the type of and format in which the product is embodied. For example, if the user were to upload a computer aided design (CAD) drawing of the product, the application manager (187) may be able to interpret the file type and open, within a browser program on the client computer (105), the appropriate application software (189). A processor (190) may be provided to allow the user to then alter the product via the network server (110).

In an example, the user may upload a word processing document such as a Microsoft® Word® document. Again, once the product has been uploaded, the user, through the use of the application server (185), the application manager (187), and the appropriate application software (189), may alter the product.

In an example, the user may use the application server (185), and more specifically the application software (189), to create an entire product. Therefore, the application software (189) implemented on the application server (185) may comprise any number and types of software that may enable a user to create, alter, and submit a product to be printed by a print shop provider (115).

Once the user has either uploaded or created a product via the network server, the user may submit the product for analysis to determine if a print shop provider (115) will print or have printed the product. The analysis may be completed by an operational module (191) that uses a master definition catalog (193) to determine which, if any print shop provider (115) may print the product. The operations module (191) receives the product and begins to analyze the product based on the user's input and the product details. The operational module (191) may, therefore, receive from the user certain printing intent parameters. The printing intent parameters may include, for example, the purpose of the product such as whether the product is meant to be used as a booklet, a brochure, or a flyer, amongst others. Additionally, the user may further define the printing intent parameters to include what the cover, binding, and page style are to look like. Still further the user may define a printing intent parameter that identifies the number of physical copies of the product to be printed, quality of the printed product, delivery deadlines, amongst others. The above listed printing intent parameters are not meant, however, to be an exhaustive list of the parameters a user may set prior to or during submission of the product to the operational module (191). Many other parameters may be set to further define how the product is to look,

Despite these efforts by the client to further define the product, the product may still contain some ambiguities. For example, the user may have previously selected a spiral binding to be integrated into the product, but the exact size of the spiral binding may not have been defined. This ambiguity may result in a spiral binding that is too large for the product. If the product is printed by a print shop provider, the spiral binding may not look appropriate for the size of the material and may additionally affect the readability or usability of the product. As such, the operational manager (191) may allow the user, through an application (189) on the application server (185) to view a three-dimensional realistic virtualization of the product. The three-dimensional realistic virtualization will allow the user to see the content and layout of the content within the product as it currently appears based on the user's previously defined printing intent parameters. This may enable the user to see a soft proof of the product and submit the final product after viewing the product and making any alterations. The user may also have the ability to review the product page by page and cover to cover so that the user may discover any ambiguities that may exist in the product.

If the user finds an ambiguity with the product, the user may change the product while viewing the three-dimensional virtualization of the product. Through this process, the user may further define and proof the product until it appears how the user had intended it to appear. In one example, the user may not have the ability to change a certain aspect of the product via the three-dimensional virtualization. This may occur when the operational module (191), through the master definition catalog (193), is unable to find a print shop provider (115) that is capable of fulfilling the request exactly and completely as the user had intended. In this case, the user may be notified of this and adjust the product specifications in another way.

In one example, once the user has approved the three-dimensional virtualization of the product, the network server (110) causes a message to be sent to a participating print shop provider (115) who is capable of generating a number of physical copies of the product. In one example, approval by the client of the three-dimensional virtualization of the product constitutes a contract between the user and the chosen print shop provider (115).

In another example, a program may be allowed to review the product and change certain aspects of the product via the three-dimensional virtualization. In this example, the program may analyze the three-dimensional virtualization by using computer vision technology or by examining the three-dimensional data used to represent the three-dimensional virtualization of the product. Using a set of rules, the program may determine if the offering was acceptable and if not, the program will be allowed to negotiate the best version for the user who submitted the product. For example, the program may determine that a print service provider does not exist that can fulfill the product requirements as detailed by the user. The program may then discover alternatives available to the user using the data stored on the master definition catalog (193). With this information, the program may take into consideration atheistic rules as well as financial rules in deciding the final look and cost of the product.

Once the user has approved the three-dimensional virtualization of the product, the network server may save a copy of the three-dimensional virtualization on a data storage device (155) for later viewing by the print shop provider (115). The stored copy may be made to be unalterable by anyone such as the print shop provider (115) so that the integrity of the transaction may be protected. If alterations are to be made, then the network server (110) may allow such an alteration only upon receiving security information such as a username or password.

In one example the message sent to the print shop provider (115) by the network server (110) may contain the data or files used to view the three-dimensional virtualization of the user's product on the print shop provider's (115) computer system. In another example, the print shop provider is notified of the request by the user and the contract being formed. In this example, the print shop provider (115) may access the network server (110) and view the three-dimensional virtualization of the product via the same or similar program (189) the user had used to view the product. Once the print shop provider (115) has seen the three-dimensional virtualization of the product, the print shop provider (115) may then begin to produce the physical copies of the product as the user had defined and approved it in the three-dimensional virtualization.

In one example, because the user had agreed to the final proof after viewing the three-dimensional virtualization of the product, the print shop provider (115) is not responsible for any features of the printed product that may or may not be to the users intended specifications. However, preview and approval of the product by the user allows the print shop provider (115) to print exactly what it seen in the three-dimensional virtualization while the user receives a product as was intended by the user. Any ambiguities in printed product are a result of the users actions or inaction during the approval process while viewing the three-dimensional virtualization.

In another example, any ambiguities in the specification of the product may be resolved by the print shop provider (115) after the print shop provider (115) has viewed the three-dimensional virtualization of the product. In this example the print shop provider (115) may confirm with the user that the changes are appropriate and proceed to produce the physical copies of the product. Consequently, the print shop provider (115) may be able to mitigate or eliminate any ambiguities in the specification of the product by agreeing with the user on how to resolve the ambiguities.

During the uploading, creation, editing, and finalizing process described above, the user may not need to know which of the print shop providers (115) are able to and are contracted to fulfill the print job. As discussed above, the operational module (191) may analyze the user finalized product. In one example, the operational module (191) may return to the user a list of available print shop providers (115) that could fulfill the printing job.

In another example, the user is not given the ability to specifically choose which print shop provider (115) will fulfill the print job. In this example, the operational module (191) may choose a print shop provider (115) based on a number of criteria such as capabilities, pricing, rating, geographical location, current workload, and combinations of these, amongst others. Therefore, in one example, a print shop provider (115) may be chosen based initially on the product requirements. For instance, if the product dictates that a comb binding or other type of binding is to be used to secure various parts or pages of the product together, any print shop provider (115) with the ability to do so will be among the possible selections In one example, the network server (110) or, more specifically, the operational module (191) may choose one out of many print shop providers (115) that can accomplish this task to print the product.

In one example the number of potential print shop providers (115) that can perform the work for the user is further limited by additional criteria such as other printing capabilities, pricing, rating, geographical location, current workload, and combinations of these, amongst others. Therefore, the user will not know exactly who among the print shop providers (115) is printing the product, but that someone among the print shop providers (115) has been chosen and is the best choice in doing the work.

Selection of the print shop provider (115) by the operational module (191) provides a system (100) that is relatively more convenient for the user to use. Having the print shop provider (115) chosen for the user prevents the user from directly contacting a large number of print shop providers (115) before the user has found one that can accommodate his or her needs. Additionally, because the user, through the three-dimensional virtualization process, has already specified the details of the product, the user will not have to contact the print shop provider (115) with any further details or otherwise review and respond to any number of drafts of the product received from the print shop provider (115).

Again, after the user has approved the three-dimensional virtualization of the product, the user may then send a message to the network server (110) to process the print job. This starts a print shop provider (115) selection process as discussed above and a print shop provider (115) is selected.

In one example, the operational module (191) may not have been able to locate a print shop provider (115) that is capable of printing the product based on the user's requirements. In this case, the user, using the three-dimensional virtualization, may compromise on certain aspects of the product. In certain situations, the user may be able to save on costs of printing the product. For example, the user may have to compromise on the type of binding used to hold the product together and may experience a drop in the cost of making the product. In another example, the user may be given the ability to adjust certain parameters of the product even though a print shop provider (115) is available to produce the product as initially stated. In this case, the user, via the three-dimensional virtualization, may adjust, for example, the type of hinging used so that lower costs may be realized. In this example, the network server (100) may provide real time costs to the user while the user is finalizing the product via the three-dimensional virtualization.

Once the print shop provider (115) is selected, the print shop provider (115) receives the information associated with the product in order to fulfill the printing request. To accomplish this, the print shop provider (115) may run a similar three-dimensional virtualization process as the user had ran. Utilization of the three-dimensional virtualization assures the print shop provider (115) that the same three-dimensional virtualization of the users' requested product is being viewed by the print shop provider (115). Therefore, during the printing process the print shop provider (115) reviews the three-dimensional virtualization of the product and prints physical copies of that product. Consequently, the print shop provider (115) is not responsible for any features of the product that the user may not necessarily have intended to be reflected in the product.

In one example, the three-dimensional virtualization process may include a specification of the production process the print shop provider (115) is to use. For example, based on the layout and characteristics of the product, the print shop provider (115) may be told, via the three-dimensional virtualization, to perform certain actions in a certain order in order to complete the printing process.

The system (100) may accommodate any number of print shop providers (115). In one example, a print shop provider (115) participating in the system (100) may be allowed to register with the system (100) those types of products they are capable of producing. Therefore, each print shop provider (115), after registering with tie system as a new print shop provider (115), may associate with their account definitions of their capabilities. These definitions may include definitions of the types of substrates they work with, folding capabilities, cutting capabilities, substrate reflectivity properties, lighting sources, and binding capabilities, among others.

The operational module (191), and more specifically, the master definition catalog (193) may own or otherwise maintain data defining the three-dimensional modeling components that are available to the client via the capabilities of the individual print shop providers' capabilities. As new print shop providers are added to the system, their capabilities are added to the master definition catalog (193). Additionally, as an individual print shop provider (115) gains new capabilities, these new capabilities may be added to the master definition catalog (193) and further associated with the print shop provider (115). In one example, the master definition catalog (193) may associate the definitions of the three-dimensional modeling components with the individual print shop providers (115) that have these capabilities. Therefore, when the operational module (191) searches for a print shop provider (115) that can provide all of the capabilities to produce physical copies of the product, the operational module (191) may refer to the master definition catalog (193) for an appropriate print shop provider (115).

In one example, the user and the print shop provider (115) may access the network server (110) under a secured protocol. Therefore, the user and print shop provider (115) may enter in specific personal information sufficient to establish an account with the network server (110). Security questions may be used to periodically gain access to the network server (110). Consequently, information such as a username, password, or email address. amongst others may be used to gain access to the network server (110).

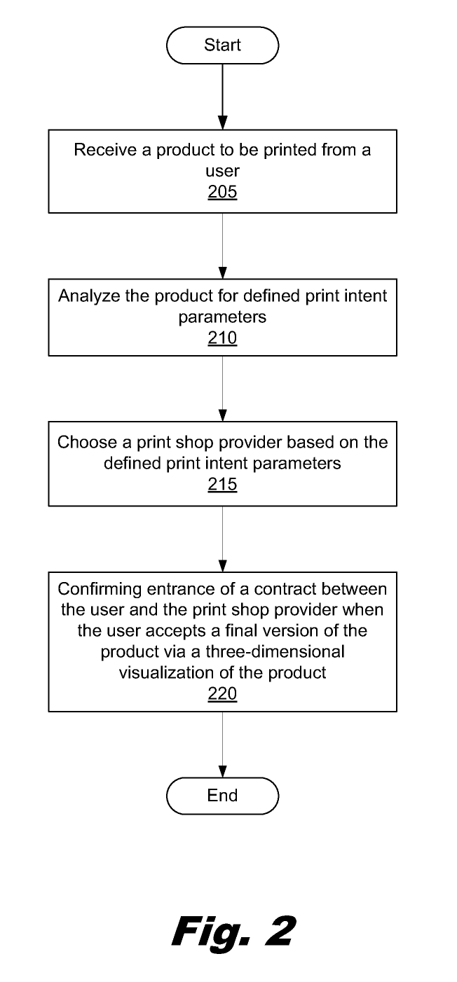

Turning now to FIG. 2, a flowchart showing a method of proofing a product for printing according to one example of the principles described herein is shown. The method may start with the network server (FIG. 1, 110) receiving (Block 205) a product to be printed from a user using the client computer (FIG. 1, 105). In one example, the user may upload to the network server (FIG. 1, 110) a file representing the project to the network server (110) after having completed the product on the client computer (FIG. 1, 105). In one example, the user may, through the network server (FIG. 1, 110), create or edit the product using application software (FIG. 1, 189) associated with the network server (FIG. 1, 110) as described above.

The network server (FIG. 1, 110) may also analyze (Block 210) the product for any defined print intent parameters that were previously defined by the user or included as part of the product's description. The analysis (Block 210) may be done specifically by the operational module (FIG. 1, 191).

Through the analyses process (Block 210) a print shop provider (FIG. 1, 115) may be chosen (Block 215) based on the defined print intent parameters discovered by the operational module (FIG. 1, 191). As described above, the print shop provider (FIG. 1, 115) may be chosen based on a number of criteria such as capabilities, pricing, rating, geographical location, current workload, and combinations of these, amongst others.

The network server (FIG. 1, 110) may then confirm (Block 220) that the user and a print shop provider (FIG. 1 115) have entered into a contract. The confirmation (Block 220) may be accompanied with an email or other message to the user and print shop provider (115) notifying them of such a contract being formed. In one example, the contract may be formed or entered into once the user has accepted a final version of the product via the three-dimensional visualization of the product as described above. Therefore, in this example, the print shop provider (FIG. 1, 115) may be chosen while the user is accepting the final version of the product. In one example, the network server (FIG. 1, 110), or more specifically, the operational module (FIG. 1, 191) may choose (Block 215) an appropriate print shop provider (FIG. 1, 115) after the client has accepted a final version of the product. in either example, a contract will be formed between a user and a print shop provider (FIG. 1, 115) once the user has accepted a final version of the product via a three-dimensional visualization of the product. Formation of the contract provides the print shop provider with a certain level of assurance that what is to be printed will reflect the user's intents.

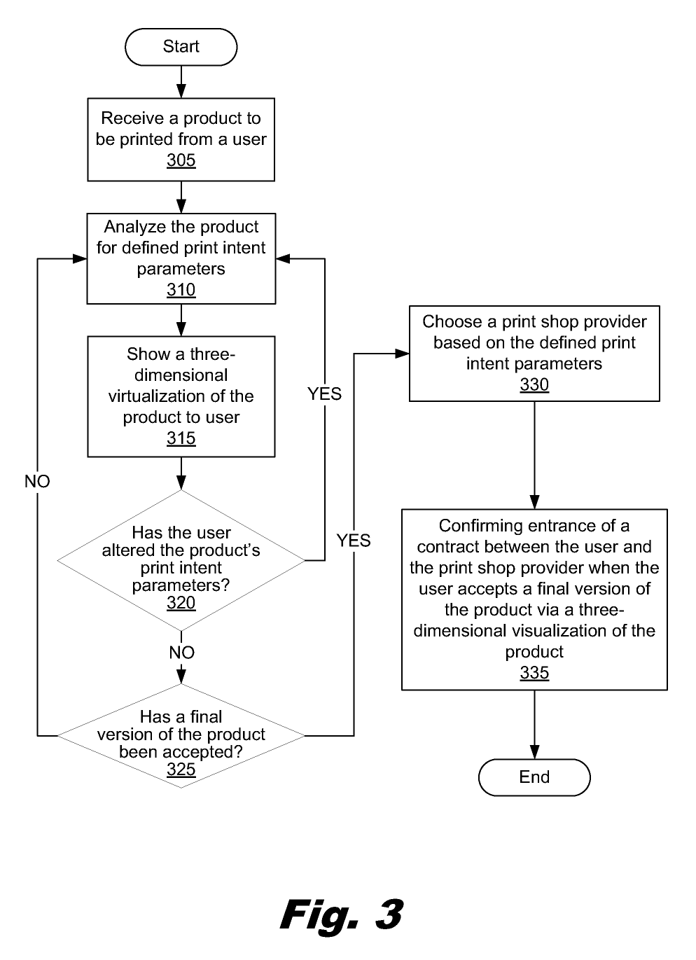

FIG. 3 is a flowchart showing another method of proofing a product for printing according to one example of the principles described herein The method may start with the network server (FIG. 1, 110) receiving (Block 305) a product to be printed from a user using the client computer (FIG. 1, 105). The network server (FIG. 1, 110) may also analyze (Block 310) the product for any defined print intent parameters that were previously defined by the user or included as part of the product's description. The analysis (Block 310) may be done specifically by the operational module (FIG. 1, 191).

Through the analyses process (Block 310) the user may be shown (Block 315) a three-dimensional virtualization of the product. As detailed above, the user may then be allowed to alter certain print intent parameters defining the product's features. The system (FIG. 1, 100) may then determine (Block 320) if the user has altered the product's print intent parameters. If the user has altered the product's print intent parameters (block 320, Determination YES), the system (FIG. 1, 100) may then again analyze (Block 310) the product for any defined print intent parameters and have those changes reflected (Block 315) in the three-dimensional visualization of the product.

If the user has not altered (Block 320, Determination NO) any print intent parameters, the user may be asked whether the version of the product seen in the three-dimensional virtualization is the final version. The system (FIG. 1, 100) may determine whether a final version of the product has been accepted (Block 325) by the user. If the user has not accepted (Block 325, Determination No) a final version of the product, the system (FIG. 1, 100) may then again analyze (Block 310) the product for any defined print intent parameters show (Block 315) the three-dimensional virtualization of the product and wait for the user to accept a final version of the product.

If the user has accepted (Block 325, Determination YES) a final version of the product, a print shop provider (FIG. 1, 115) may be chosen (Block 330) based on the defined print intent parameters discovered by the operational module (FIG. 1, 191). The network server (FIG. 1, 110) may then confirm (Block 335) that the user and a print shop provider (FIG. 1, 115) have entered into a contract.

The methods described above may be accomplished in conjunction with a computer program product comprising a computer readable medium having computer usable program code embodied therewith that, when executed by a processor, performs the above processes and methods. Specifically, the computer program product receives a product to be printed from a user and analyzes the product for defined print intent parameters. Further, the computer program product chooses a print shop provider (FIG. 1, 15) based on the defined print intent parameters and confirms that a contract between the user and the print shop provider (FIG. 1, 115) is entered into after the user has accepted a final version of the product via a three-dimensional visualization of the product. The computer program product may choose the print shop provider (FIG. 1, 115) based on a number of criteria such as capabilities, pricing, rating, geographical location, current workload, and combinations of these, amongst others.

The computer program product may analyze the product after the user has accepted the final version of the product. The computer program product may also cause a number of notices to be sent to the user and the print shop provider (FIG. 1, 115) indicating that a contract has been formed between the two parties. The notices may be in the form of an email or pop-up window, amongst others.

The specification and figures describe a system and method for proofing a product over a network, The present system and method enables soft proofing of the production and seamless submission of the job to the print shop provider. The present system and method also enhances the formulation of the communication between a user and a print shop provider by using a three-dimensional virtualization over a network such as a cloud computing environment. Additionally, the system and method described may reduce and even eliminate the number of proof iterations between the user and the print shop provider. Further, the present system and method facilitates a meeting place between users and print shop providers and standardizes the process of proofing by the use of a master definition catalog which includes three-dimensional virtualization controls and calibrations.

The preceding description has been presented to illustrate and describe examples of the principles described, This description is not intended to be exhaustive or to limit these principles to any precise form disclosed. Many modifications and variations are possible in light of the above teaching.

What is claimed is:

1. A system for proofing a product over a network, comprising:
a first computing device (110) that receives a product from a user;
an operational module (191) that analyzes the product for print intent parameters; and
a second computing device (185) that allows user to finalize the product through a three-dimensional visualization;
in which finalization by the user of the product causes a contract to be established between the user and a selected print shop provider (115),

2. The system of claim 1, in which the second computing device 185) further comprises an application manager (187) that allows a user to create a product through a network connection using software (189) associated with the application manager (187).

3. The system of claim 1, in which the operational module (191) selects the print shop provider (115) based on the print intent parameters and the print shop providers (115) capabilities.

4. The system of claim 1, in which the second computing device (185) provides the print shop provider (115) with the three-dimensional visualization of the product and in which three-dimensional visualization of the product provides the print shop provider (115) with instructions as to how to print physical copies of the product.

5. The system of claim 1, in which the second computing device (185) further includes an application manager (187) which detects the format in which the product is embodied.

6. The system of claim 1, in which the operational module (191) further comprises a master definition catalog (193), the master definition catalog (193) maintaining date defining three-dimensional modeling components that are available to the user so that the user may use to further define characteristics of the product through the three-dimensional virtualization.

7. The system of claim 1, in which the user may full e the product by defining the purpose of the product, the paper style that the product is to be printed on, the cover and page style, binding type, areas of the product to be folded, and combinations thereof.

8. A method of proofing a product for printing comprising:
receiving (205) a product to be printed from a user;
analyzing (210) the product for defined intent parameters;
choosing (215) a print shop provider (115) based, in part, on the defined print intent parameters; and
confirming (220) entrance of a contract between the user and the print shop provider (115) when the user accepts a final version of the product via a three-dimensional visualization of the product.

9. The method of claim 8, further comprising choosing the print shop provider (115) based on the print shop provider's (115) ability to produce a physical copy of the product based on the defined print intent parameters.

10. The method of claim 8, in which a three-dimensional virtualization of the product is provided to the print shop provider (115) to provide directions regarding how to print physical copies of the product.

11. The method of claim 8, further comprising detecting the format at in which the product is embodied.

12. The method of claim 8, in which choosing a print shop provider (115) further comprises referencing a master definition catalog (193), the master definition catalog (193) maintaining data defining three-dimensional modeling components that are associated with the print shop provider's (115) capabilities,

13. The method of claim in which finalization of the product by the user further comprises referencing a master definition catalog (193), the master definition catalog (193) defining three-dimensional modeling components that are available to the user to further define characteristics of the product through the three-dimensional virtualization.

14. The method of claim 8, in which finalization of the product further comprises defining the purpose of the product, the paper style that the product is to be printed on, the cover and page style, binding type, areas of the product to be folded, and combinations thereof.

15. A computer program product for proofing product for printing, the computer program product comprising:
a computer readable storage medium having computer usable program code embodied therewith, the computer usable program code comprising:
computer usable program code that receives (205) a product to be printed from a user;
computer usable program code that analyzes (210) the product for defined print intent parameters;
computer usable program code that chooses (215) a print shop provider (115) based on the print intent parameters and the print shop provider's (115) ability to produce a physical copy of the product based on the defined print intent parameters; and
computer usable program code that confirms (220) entrance of a contract between the user and the print shop provider (115) when the user accepts a final version of the product via a three-dimensional visualization of the product.
